(19) United States
(12) Patent Application Publication
(10) Pub. No.: US 2009/0175561 A1
(43) Pub. Date: Jul. 9, 2009

(54) METHOD AND SYSTEM FOR RETRIEVING AND DISPLAYING IMAGES OF DEVICES CONNECTED TO A COMPUTING DEVICE

(75) Inventor: Patrick C. Lankswert, Louisville, KY (US)

Correspondence Address: STITES & HARBISON, PLLC, 400 W MARKET ST, SUITE 1800, LOUISVILLE, KY, 40202-3352, US

(73) Assignee: Stonestreet One, Inc., Louisville, KY (US)

(21) Appl. No.: 12/347,535

(22) Filed: Dec. 31, 2008

Related U.S. Application Data
(60) Provisional application No. 61/018,803, filed on Jan. 3, 2008.

(51) Int. Cl. G06K 9/60

(52) U.S. Cl. 382/305

(57) ABSTRACT

A method for retrieving and displaying a photorealistic image of a device that is connected to a computing device or available for connection comprises the steps of: using the computing device to receive data from the device; using the computing device to retrieve identifying information from the device; using the computing device to retrieve a photorealistic image from a database based on the identifying information; and displaying the retrieved photorealistic image on the computing device.

### CROSS-REFERENCE TO RELATED APPLICATIONS

The present application claims priority to U.S. Provisional Patent Application Ser. No. 61/018,803 filed on Jan. 3, 2008, the entire disclosure of which is incorporated herein by reference.

### BACKGROUND OF THE INVENTION

The present invention relates to a method and system for retrieving and displaying images of devices that are connected to a computing device or available for connection.

Computing devices are often connected to each other via wireless and wired networks. For example, mobile computing devices, such as laptop computers, often look for and/or are connected to networks as they are transported from one location to another. Since mobile computing devices operate in various locations, operating systems installed on a mobile computing device, such as Microsoft Windows®, often display an icon that indicates that a particular device is connected to the mobile computing device or available for connection. However, such an icon is typically generic. For example, in Microsoft Windows®, each printer that would be connected to the mobile computing device or available for connection would be represented by an identical generic icon. Therefore, in an environment where a mobile computing device may be able to connect to multiple different printers, it may be unclear as to where a print job is directed when the print command is given.

Accordingly, there remains a need for a means by which devices connected to a computing device or available for connection can be readily identified.

### SUMMARY OF THE INVENTION

The present invention is a method and system for retrieving and displaying images of devices that are connected to a computing device or available for connection.

An exemplary method in accordance with the present invention commences when the computing device receives data from a device present and/or available for connection in a location at a given time. From this data, certain identifying information about the device is retrieved. For example, in certified USB devices, each device is provided with a vendor ID (VID) and a product ID (PID), so both the VID and PID can be retrieved. Alternatively, identifying information may be in the form of a serial number or other information from the device. Once the identifying information has been retrieved, a local database (resident on the computing device) is first queried to determine if there is an image stored in the local database that is associated with the identifying information. In this regard, the stored images are photorealistic images of devices. In this context, “photorealistic” refers to photographic images or computer-generated images that are substantially accurate, pictorial representations of the devices, as opposed to generic icons representative of a general type of device. Then, if there is a “match” at decision, the photorealistic image from the local database that is associated with the identifying information is displayed.

If there is no “match,” a remote database is accessed via a network connection (such as an Internet connection). Specifically, the identifying information is passed through to the remote database to retrieve a photorealistic image of the device based on the identifying information. The retrieved photorealistic image is then displayed. The local database may then be updated to store the retrieved photorealistic image and associate it with the identifying information, so when the same device is encountered in the future, the photorealistic image can be retrieved from the local database.

An exemplary system for carrying out the method described above includes a computing device, such as a laptop computer, that has one or more radios, such as Bluetooth® radio, a WAN radio, and an 802.11 (or WiFi) radio. The computing device hosts a digital computer program that includes appropriate modules for executing the requisite instructions for performing the operational steps of the method: (a) a radio management module for receiving data about each wireless device present and/or available for connection in the location; (b) an information retrieval module for retrieving identifying information from each device; (c) an analysis module for querying the local database to determine if there is a photorealistic image stored in the local database that is associated with the identifying information; (d) an second analysis module for connecting to (through a network connection) and querying the remote database to retrieve a photorealistic image of the device based on the identifying information; and (e) a display for displaying the retrieved photorealistic image.

### DESCRIPTION OF THE DRAWINGS

FIG. 1 is a flow chart illustrating an exemplary method for retrieving and displaying images of devices that are connected to a computing device or available for connection in accordance with the present invention;

FIG. 1A is a flow chart illustrating an technique for matching a device present and/or available for connection with a photorealistic image as part of the exemplary method of FIG. 1;

FIG. 2 illustrates a console screen of an exemplary user interface application module of a system and method for multi-radio control in a mobile computing device; and

FIG. 3 illustrates the core components of an exemplary system in accordance with the present invention.

### DETAILED DESCRIPTION OF THE INVENTION

The present invention is a method and system for retrieving and displaying images of devices that are connected to a computing device or available for connection.

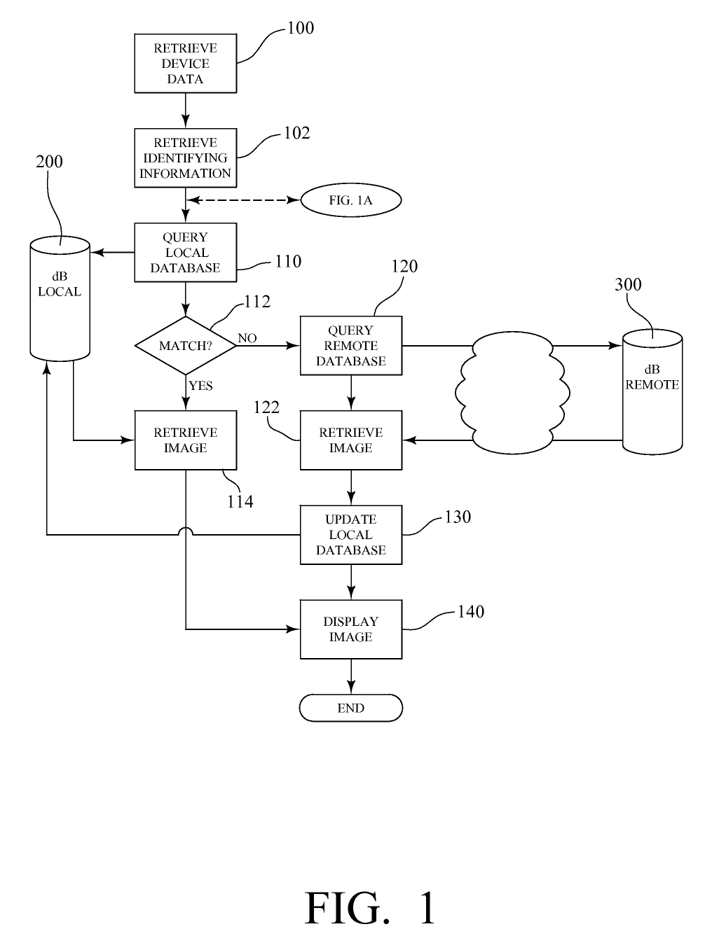

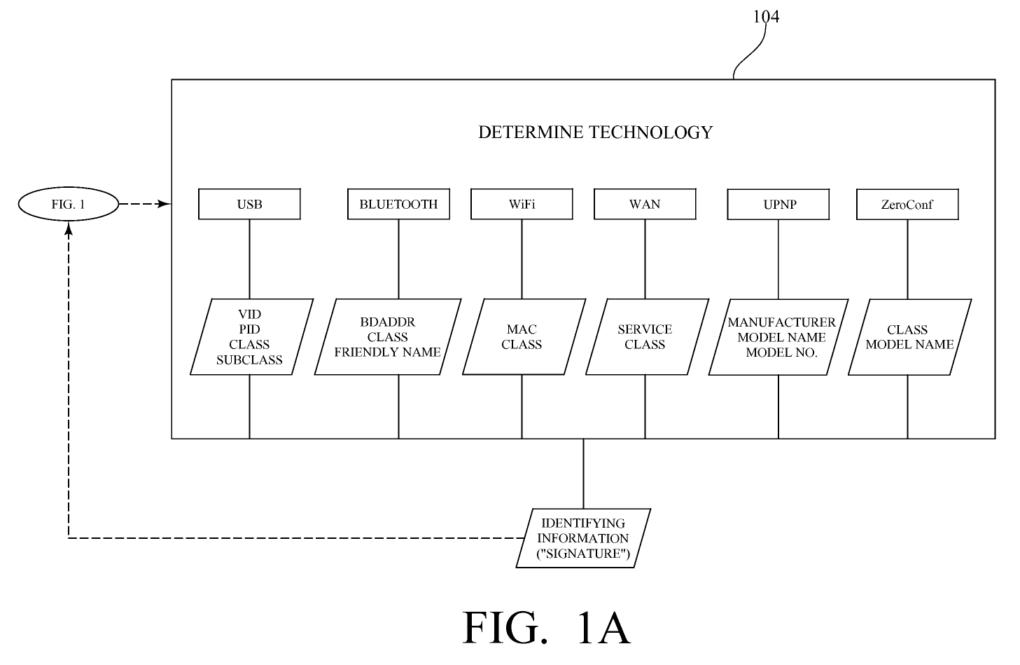

FIG. 1 is a flow chart illustrating an exemplary method for retrieving and displaying images of devices that are connected to a computing device or available for connection in accordance with the present invention. As will become clear in the description that follows, the operational steps of this method are preferably achieved through the use of a digital computer program, i.e., computer-readable instructions stored and executed by a computer. Accordingly, the computing device that is connected to and/or is looking for connections to other devices hosts a digital computer program stored on a computer-readable medium that includes appropriate modules for executing the requisite instructions. Such instructions can be coded into a computer-readable form using standard programming techniques and languages, and with benefit of the following description, such programming is readily accomplished by one of ordinary skill in the art.

Referring still to FIG. 1, the method commences when the computing device receives data from a device present and/or available for connection in a location at a given time, as indicated by step 100. From this data, certain identifying information about the device is retrieved, as indicated by block 102. For example, in certified USB devices, each device is provided with a vendor ID (VID) and a product ID (PID), so both the VID and PID can be retrieved. Alternatively, identifying information may be in the form of a serial number or other information from the device, as is further described below with reference to Table A and FIG. 1A. In any event, once the identifying information has been retrieved, a local database 200 (resident on the computing device) is first queried to determine if there is an image stored in the local database 200 that is associated with the identifying information, as indicated by block 110. In this regard, the stored images are photorealistic images of devices. In this context, “photorealistic” refers to photographic images or computer-generated images that are substantially accurate, pictorial representations of the devices, as opposed to generic icons representative of a general type of device. Then, if there is a “match” at decision 112, the photorealistic image from the local database 200 that is associated with the identifying information is retrieved, as indicated by block 114, and then displayed, as indicated by block 140.

If there is no “match” at decision 112, a remote database 300 is accessed via a network connection (such as an Internet connection), as indicated by block 120. Specifically, the identifying information is passed through to the remote database 300 to retrieve a photorealistic image of the device based on the identifying information, as indicated by block 122.

With respect to this matching process, one exemplary technique for matching a device present and/or available for connection with a photorealistic image involves using the computing device to assemble a “signature” for the device present and/or available for connection, and then passing this signature through to the local database 200 or remote database 300 for the query to retrieve the photorealistic image. Such a signature may be associated, in part, with the technology (i.e., a mode of communication) that led to the discovery and identification of the device by the computing device. For example, Table A (below) provides an identification of six technologies commonly used for the discovery and identification of devices, along with attributes (i.e., items of identifying information) that can be retrieved from each device.

TABLE A

| Technology | Attributes |
|---|---|
| USB | Vendor ID (VID) |
| | Product ID (PID) |
| | Class of Device |
| | Subclass of Device |
| Bluetooth | Bluetooth Address (BDADDR) |
| | Class of Device |
| | Friendly Name |
| WiFi | Ethernet Address (MAC) |
| | Class of Device (implied) |
| WAN | Service Name |
| | Class of Device (implied) |
| UPNP | Manufacturer |
| | Model Name |
| | Model Number |
| ZeroConf | Class |
| | Model Name |

Thus, the identifying information may be in the form of a signature assembled from one or more selected attributes associated with a particular technology, as set forth in Table A.

Accordingly, in this exemplary technique and as illustrated in FIG. 1A, once the identifying information has been retrieved, and prior to querying the local database 200 or the remote database 300, a determination is made as to the technology that led to the discovery and identification of the device, as indicated by block 104. In this example, and as reflected in Table A (above), there are six possible technologies—Bluetooth®; Universal Serial Bus (USB); WiFi, WAN; Universal Plug and Play (UPNP); and Zero Configuration Networking (ZeroConf). Of course, additional technologies could certainly be considered without departing from the spirit and scope of the present invention. Depending on the determination as to the technology that led to the discovery and identification of the device, the local database 200 and/or the remote database 300 can then be queried with the identifying information in the form of a signature assembled from one or more attributes associated with that technology. In other words, the attributes embodied in a signature can be used individually or collectively as the identifying information in the querying of the local database 200 and/or the remote database 300. In this regard, each entry in the respective databases 200, 300 may be assigned a confidence value that indicates the precision of the match for a given attribute (i.e., item of identifying information). Accordingly, should queries of the respective databases 200, 300 based on given attributes return more than one result, the querying process would return a photorealistic image with the highest confidence value.

For example, and referring still to FIG. 1A, if a certified USB device is discovered and identified, the identifying information for the querying of the local database 200 and/or the remote database 300 may be some combination of the VID, PID, the class of the device, and/or the subclass of the device.

For another example, and referring still to FIG. 1A, if a Bluetooth® device is discovered and identified, the identifying information for the querying of the local database 200 and/or the remote database 300 may be some combination of the Bluetooth Address (BDADDR), the class of the device, and/or the “friendly name” assigned to the device.

For another example, and referring still to FIG. 1A, if a WiFi device is discovered and identified, the identifying information for the querying of the local database 200 and/or the remote database 300 may be some combination of the Ethernet Address (MAC) and/or the class of the device.

For another example, and referring still to FIG. 1A, if a WAN device is discovered and identified, the identifying information for the querying of the local database 200 and/or the remote database 300 may be some combination of the service name and/or the class of the device.

For another example, and referring still to FIG. 1A, if a UPNP device is discovered and identified, the identifying information for the querying of the local database 200 and/or the remote database 300 may be some combination of the manufacturer, model name, and/or model number of the device.

For another example, and referring still to FIG. 1A, if a ZeroConf device is discovered and identified, the identifying information for the querying of the local database 200 and/or the remote database 300 may be some combination of class of the device and/or the model name.

Returning now to FIG. 1, with respect to the actual retrieval of the photorealistic image, one technique to retrieve the photorealistic image is through the use of an XML-based messaging protocol in which a Simple Object Access Protocol (SOAP) request is transmitted to the remote database 300 with the identifying information, with the resultant photorealistic image then being returned as a SOAP response.

Finally, regardless of what type of identifying information is used and regardless of what type of messaging protocol is utilized, the retrieved photorealistic image is then displayed, as indicated by block 140. Furthermore, the local database 200 may then be updated to store the retrieved photorealistic image and associate it with the identifying information, as indicated by block 130, so when the same device is encountered in the future, the photorealistic image can be retrieved from the local database 200.

From the above discussion, it should be clear that to the extent that an exact “match” may not be found in the local database 200 or the remote database 300, a “close” image may still be retrieved. For instance, if the identifying information indicates that the device is a router manufactured by a certain company, but the specific model in unknown, an photorealistic image representative of a router manufactured by that company may nonetheless be retrieved and displayed.

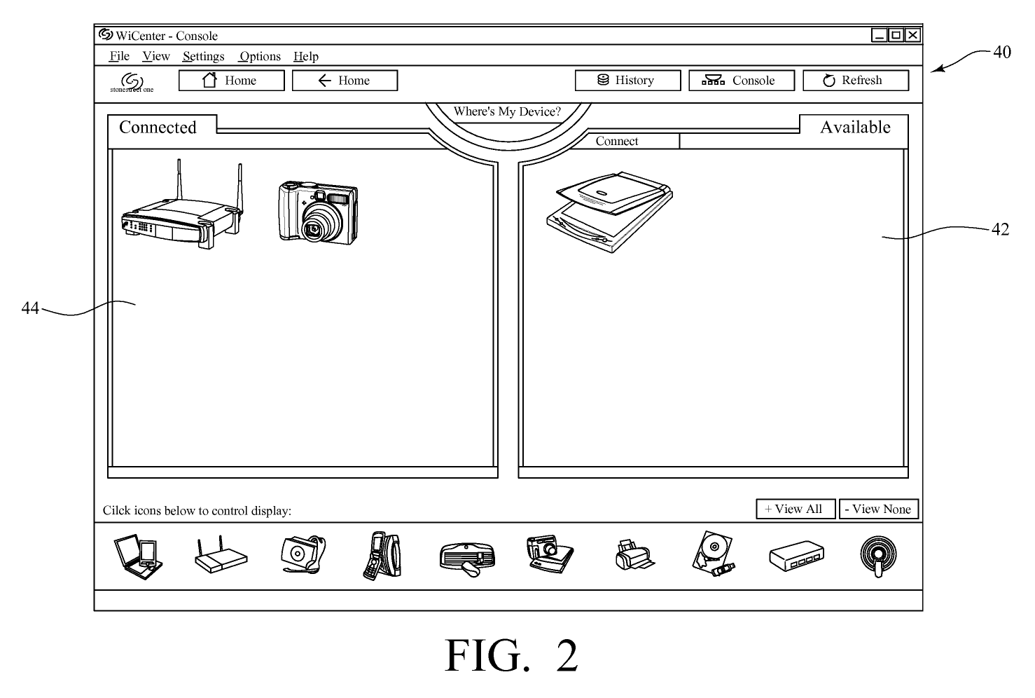

With respect to the display of the photorealistic image, the method and system of the present invention may be particularly useful in cooperation with a user interface application module of a system and method for multi-radio control in a mobile computing device, such as that described in U.S. Patent Publication No. 2007/0275683 and assigned to the assignee of the current application, the entire disclosure of which is incorporated herein by reference. Referring now to FIG. 2, such a user interface application module may generate a console screen 40 subdivided into an Available window 42 and a Connected window 44, wherein the Available window 42 provides a display of photorealistic images representing remote devices available for connection, while the Connected window 44 provides a display of photorealistic images representing remote devices to which the mobile computing device is connected.

As a further refinement, it is also contemplated that multiple photorealistic images could actually be retrieved from the local database 200 or the remote database 300 for a single device. For example, photorealistic images of various sizes could be stored in the databases 200, 300, with an appropriate photorealistic image for display selected based on the particular application or use of the photorealistic image.

As yet a further refinement, it is also contemplated that additional information about a device could be retrieved from the local database 200 or the remote database 300. For example, a text description of the device could be retrieved for display with the photorealistic image of the device. For another example, information about radios supported by the device could be retrieved, as could information regarding the preferred connection methods for the device.

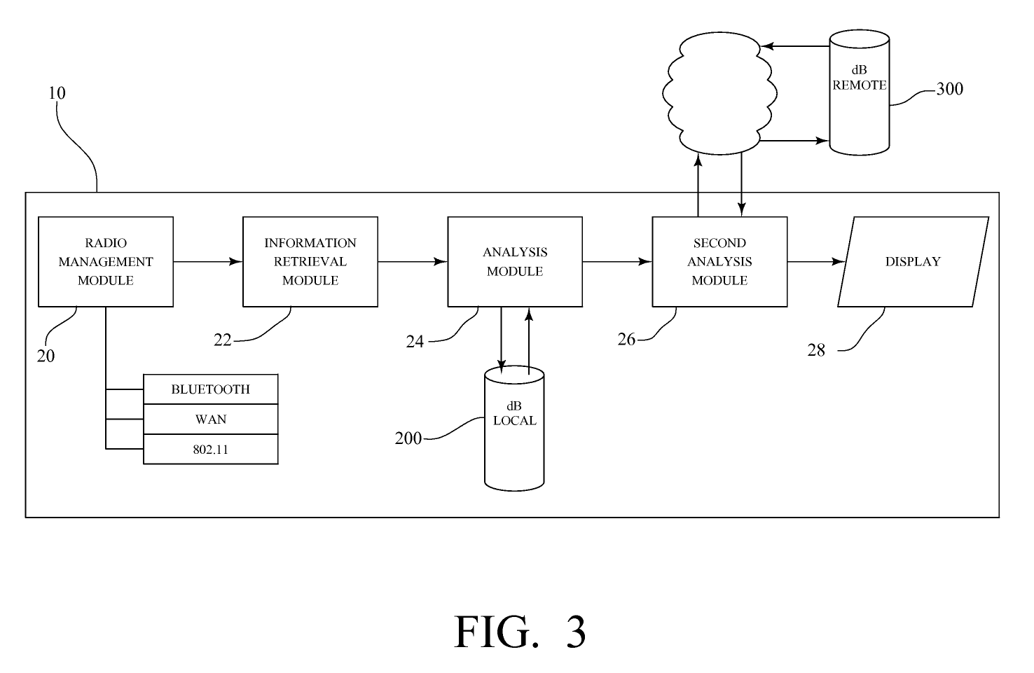

FIG. 3 illustrates the core components of an exemplary system for carrying out the method described above. The computing device 10, such as a laptop computer, has one or more radios, such as Bluetooth® radio, a WAN radio, and an 802.11 (or WiFi) radio. The computing device 10 hosts a digital computer program that includes appropriate modules for executing the requisite instructions for performing the operational steps of the method: (a) a radio management module 20 for receiving data about each wireless device present and/or available for connection in the location; (b) an information retrieval module 22 for retrieving identifying information from each device; (c) an analysis module 24 for querying the local database 200 to determine if there is a photorealistic image stored in the local database 200 that is associated with the identifying information; (d) an second analysis module 26 for connecting to (through a network connection) and querying the remote database 300 to retrieve a photorealistic image of the device based on the identifying information; and (e) a display 28 for displaying the retrieved photorealistic image.

One of ordinary skill in the art will recognize that additional embodiments and implementations are also possible without departing from the teachings of the present invention or the scope of the claims which follow. This detailed description, and particularly the specific details of the exemplary implementation disclosed, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. A method for retrieving and displaying a photorealistic image of a device that is connected to a computing device or available for connection, comprising the steps of:
using the computing device to receive data from the device;
using the computing device to retrieve identifying information from the device;
using the computing device to retrieve a photorealistic image from a database based on the identifying information; and
displaying the retrieved photorealistic image on the computing device.

2. The method as recited in claim 1, in which the identifying information is associated with a particular mode of communication.

3. The method as recited in claim 2, in which the identifying information is in the form of a signature assembled from one or more selected attributes associated with the particular mode of communication.

4. The method as recited in claim 1, in which the identifying information retrieved from the device includes a vendor ID (VID) and a product ID (PID).

5. The method as recited in claim 1, in which additional information about the device is retrieved along with the photorealistic image.

6. A method for retrieving and displaying a photorealistic image of a device that is connected to a computing device or available for connection, comprising the steps of:
using the computing device to receive data from the device;
using the computing device to retrieve identifying information from the device;
using the computing device to query a local database to determine if there is a photorealistic image stored in the local database that is associated with the identifying information;
if so, using the computing device to retrieve the photorealistic image from the local database;
if there is no photorealistic image stored in the local database that is associated with the identifying information, using the computing device to query a remote database to retrieve a photorealistic image of the device based on the identifying information; and
displaying the retrieved photorealistic image on the computing device.

7. The method as recited in claim 6, and further comprising the step of updating the local database to store the retrieved photorealistic image and associate it with the identifying information if the photorealistic image was retrieved from the remote database.

8. The method as recited in claim 6, in which the identifying information is associated with a particular mode of communication.

9. The method as recited in claim 8, in which the identifying information is in the form of a signature assembled from one or more selected attributes associated with the particular mode of communication.

10. The method as recited in claim 6, in which the identifying information retrieved from the device includes a vendor ID (VID) and a product ID (PID).

11. The method as recited in claim 6, in which additional information about the device is retrieved along with the photorealistic image.

12. The method as recited in claim 6, in which the remote database is accessed by the computing device via a network connection.

13. The method as recited in claim 12, in which the remote database is queried through use of an XML-based messaging protocol in which a Simple Object Access Protocol (SOAP) request is transmitted to the remote database with the identifying information, with the retrieved photorealistic image then being returned as a SOAP response.

14. A method for retrieving and displaying a photorealistic image of a device that is connected to a computing device or available for connection, comprising the steps of:
using the computing device to receive data from the device;
using the computing device to retrieve identifying information from the device;
using the computing device to query a local database to determine if there is a photorealistic image stored in the local database that is associated with the identifying information;
if so, using the computing device to retrieve the photorealistic image from the local database;
if there is no photorealistic image stored in the local database that is associated with the identifying information, using the computing device to query a remote database to determine if there is a photorealistic image stored in the remote database that is associated with the identifying information;
if so, using the computing device to retrieve the photorealistic image from the local database;
if there is no photorealistic image stored in the remote database that is associated with the identifying information, using the computing device to retrieve a photorealistic image that is representative of the device from either the local database or the remote database; and
displaying the retrieved photorealistic image on the computing device.

15. The method as recited in claim 14, in which the identifying information is associated with a particular mode of communication.

16. The method as recited in claim 15, in which the identifying information is in the form of a signature assembled from one or more selected attributes associated with the particular mode of communication.

17. The method as recited in claim 14, in which the identifying information retrieved from the device includes a vendor ID (VID) and a product ID (PID).

18. The method as recited in claim 14, in which additional information about the device is retrieved along with the photorealistic image.

19. The method as recited in claim 14, in which the remote database is accessed by the computing device via a network connection.

20. The method as recited in claim 19, in which the remote database is queried through use of an XML-based messaging protocol in which a Simple Object Access Protocol (SOAP) request is transmitted to the remote database with the identifying information, with the retrieved photorealistic image then being returned as a SOAP response.
